(19) United States
(12) Patent Application Publication
(10) Pub. No.: US 2010/0318433 A1
(43) Pub. Date: Dec. 16, 2010

(54) System and Method For Attracting Motivated Bidders To On-Line Auction Site

(75) Inventor: Leon Kuperman, Encino, CA (US)

Correspondence Address: SELDON & SCILLIERI, 10940 WILSHIRE BLVD., 18TH FLOOR, LOS ANGELES, CA, 90024-3952, US

(73) Assignee: Bidz.com Inc., Culver City, CA (US)

(21) Appl. No.: 12/484,543

(22) Filed: Jun. 15, 2009

(51) Int. Cl. G06Q 30/00; G06F 3/048

(52) U.S. Cl. 705/14.71; 705/27; 715/760

(57) ABSTRACT

A system for diverting motivated bidders from a publisher's webpage to an on-line auction site comprises an auction website server hosting an on-line auction and having an xml file with which a potential bidder's web browser can communicate via a banner ad displayed at a publisher's website to request a list of authorized domains having access rights to communicate with the on-line auction server. Means are provided for permitting the potential bidder's web browser to open a channel of communication to the auction website's webpage in http or https format to obtain a listing from the on-line auction website of at least one auction at the on-line auction website that is ending soon and which meets search criteria specific to the publisher's webpage as previously selected by one or both of the on-line website and the publisher. The listing is in http or https format and is displayed as real-time content within the banner ad.

Means are further provided for establishing a request loop between the viewer's web browser and the on-line auction website that periodically updates the content in the banner ad to reflect, in essentially real time, updated data pertaining to the auction(s) listed within the banner ad. The updated data includes the then-winning bid and the time remaining until auction close.

Means are further provided for permitting the potential bidder to click through to the on-line auction website via the banner ad to participate in the listed auction.

### BACKGROUND

1. Field of the Invention

This invention relates to digital data-transferring systems and methods that establish a dialogue with a remote computer to transfer data therebetween.

2. Description of the Prior Art

On-line auctions are an increasingly popular vehicle for buying and selling merchandise. In addition to the ability of on-line auctions to attract consumers and sellers from around the globe, these auctions provide an excitement that transcends the comparatively mundane purchasing of fixed-price items.

The structure of the conventional on-line auction is well known. An item is offered for a fixed time period, sometimes with a minimum starting bid and sometimes with a reserve; i.e., the item is withdrawn if a desired minimally acceptable amount is not bid. At the end of the fixed period, the highest bidder obtains the item subject to any reserve or minimum bid requirements.

As with any auction, the most successful on-line auctions are those that attract the greatest number of motivated bidders. Consequently, effective promotion of an on-line auction site is critical to its success.

One known form of Internet advertising is the banner ad, which is embedded into a web page to attract traffic to the advertiser's website by providing a link to that website. Typical banner ads include a GIF, JPEG or PNG image, a JavaScript program and/or a multimedia object employing technologies such as Java, Shockwave or Flash. The content of the banner ad sometimes includes animation, sound, or video to attract attention. The banner ad itself is typically wide and short, or tall and narrow, and are typically placed on web pages having content that, in the advertiser's opinion, attracts likely potential customers

The banner ad is displayed when a web page displaying the ad is loaded into a viewer's web browser. When the viewer clicks on the banner, the viewer is typically directed to the website advertised in the banner (hereinafter, the “target webpage”). This event is known as a “click through”.

Typically, the third party provider (hereinafter, the “publisher”) of the webpage displaying the banner ad is independent of the advertiser, and is compensated based on any of a number of criteria. For example, the publisher may be compensated by the advertiser based on the number of people seeing the banner ad, the number of people clicking through to the target webpage, the number of people who click through to the target webpage and thereafter complete a registration form, or the number of people who click through to the target webpage and become a paying customer of the advertiser. These payment bases, as well as any other mutually agreeable compensation structures, provide the financial consideration to the publisher for hosting the banner ad.

### SUMMARY

The system and method herein create a banner ad for an on-line action site that is intended to effectively attract motivated bidders. More specifically, the method and system, using the http or https protocol, create a real time view within the boundaries of the banner ad of one or more on-going auctions as they are taking place at the on-line auction site. The method and system create a display on the publisher's webpage that includes a photograph (or other image) of the auctioned product(s), together with relevant information pertaining to the displayed auction(s) that is intended to entice the viewer to click through; for example, a brief product description, the current bid, the time left to bid, etc. Upon seeing the banner ad while visiting the publisher's website, the viewer becomes caught up in the excitement of the auction and, by clicking through, is promptly transported to the auction site's web page to participate in the auction. The status of the on-line auction(s) viewed within the border of the banner ad is refreshed and updated in real time so that the viewer of the banner ad is constantly getting updated bid information, “time left” information and, if desired by publisher and/or advertiser, other auction-related information such as the “current winner” information.

### THE DRAWING

FIG. 1 herein is an illustration of a webpage containing a banner ad in accordance with the invention; and

FIG. 2 is a schematic illustration of a system constructed and used in accordance with the invention.

### DESCRIPTION OF THE PREFERRED EMBODIMENT

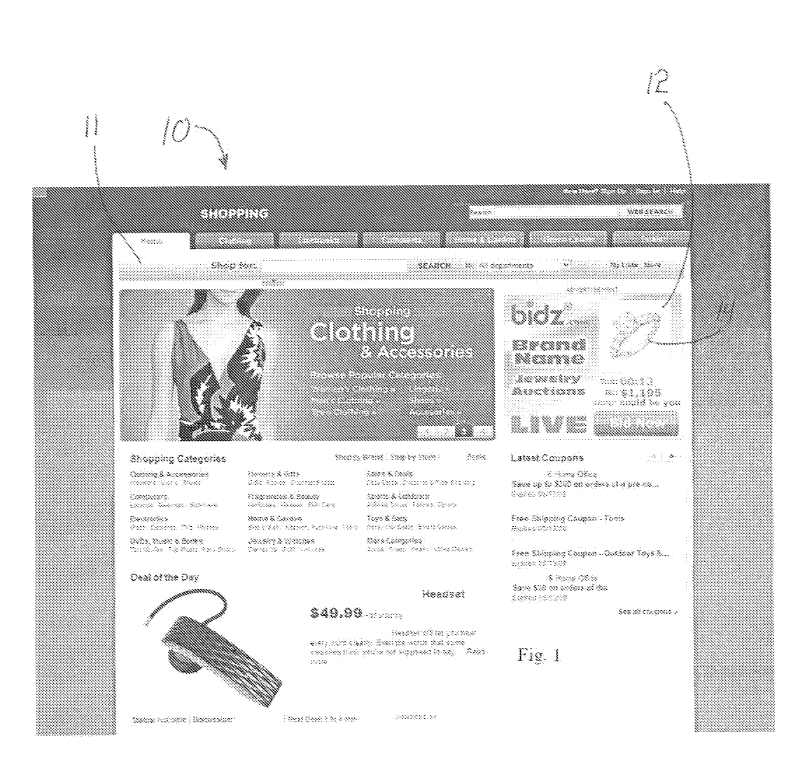

FIG. 1 is an illustration of a third party webpage containing content 10. A banner ad 12 by an on-line auction site (hereinafter, the “advertiser”) is displayed in accordance with the invention. Those of ordinary skill in the art will understand that the banner ad may be placed on any webpage and at any location on the page, as agreed upon by the publisher and advertiser. The webpage can be devoted to news, entertainment, shopping, blogging or any other topic or activity.

The banner ad 12 illustrated in FIG. 1 displays a product 14 that is the subject of an on-going auction at the advertiser's website at that moment, and is arranged to attract the attention of the viewer and motivate the viewer to join the displayed auction. Accordingly, pertinent information 15 is displayed next to a photograph of the item 14, such as a short description of the product, the currently winning bid, and the time remaining until auction close.

The displayed auctions may be limited by the publisher to items meeting the publisher's criteria, utilizing search criteria entered by the publisher. The search criteria may be amended by the publisher at any time, as well, or during time periods mutually agreed upon by the publisher and advertiser. Alternatively, the displayed auctions may be determined by the advertiser. In addition, some aspects (e.g., items displayed) may be controlled by the publisher, while other aspects (e.g., time remaining to auction close) may be limited by the advertiser. These selectable parameters, as well as the selecting part, are determined by the degree of control to be afforded the publisher and/or the advertiser which, in turn, typically depends on the basis for which compensation is to be paid to the publisher.

Since the displayed item and its relevant information is displayed in real time and is therefore highly relevant, the tendency of the banner ad is to grab the viewer's attention with the sudden awareness that the auction is ongoing at that very moment and is scheduled to end soon. Under such circumstances, the viewer is more likely to click through to the auction webpage and bid on the item.

In preferred operation, the viewer's browser opens a channel of communication to the advertiser's webpage through http or https, and requests a listing of auctions ending soon that meet other search criteria, if any, established by the publisher or the advertiser pursuant to their agreement. For example, the displayed items may be restricted to brand name items only, or to certain types of items; e.g., jewelry. Any number of search criteria can be specified as related to the auction item characteristics; this is a matter to be determined by the auction-site advertiser and/or the publisher per the terms and conditions of the Agreement they enter into pertaining to the banner ad. Likewise, the specific auction(s) and the number of auctions returned, and the amount of banner space available (to render the ad legible), can be included within the terms and conditions of the agreement between the advertiser and publisher in addition to the publisher's (and/or advertiser's) stored search criteria that are applicable to requests emanating from the publisher's webpage.

Using the http format, the banner content displaying the on-going auction is sent to the viewer's browser from the advertiser's server. Ideally, the content within the banner is identical in appearance to that content as displayed at the on-line auction site's webpage associated with the displayed auction; however, the displayed appearances do not have to be the same. This, as well, as all other characteristics of the user interface provided by the banner ad is a matter of ad design.

The viewer's browser then initiates a request loop to obtain periodic updates concerning the status of the auction(s) displayed within the banner ad. It will be understood that more than one auction may be displayed within the banner ad. Generally, it is highly preferable that the banner ad be sufficiently sized to display the item clearly and the pertinent information legibly. In addition, the display of too many auctions is believed to be counterproductive in that the viewer will lose focus and be overwhelmed by an overload of information.

As the viewer watched the banner ad 12, the displayed time decrements towards zero in real time as the on-line auction at the auction website progresses toward closure, and the then-winning bid and bidder that are displayed are the winning bid and bidder at the displayed auction at the auction website. The banner ad displays the changing information as it changes in real time (delayed only by the interval between updates).

In practice, a request for the displayed auction(s) update sent once per second appears to be satisfactory. The data sought by the request preferably includes the time remaining until auction close, the screen name (or other identity) of the currently winning bidder, and the amount of the currently winning bid. This data is all presented to the viewer within the borders of the banner ad in real time. At the close of the auction, the winning bid and bidder's screen name is preferably displayed, a request for a listing of auctions meeting the requisite criteria is sent again, and the process repeats itself.

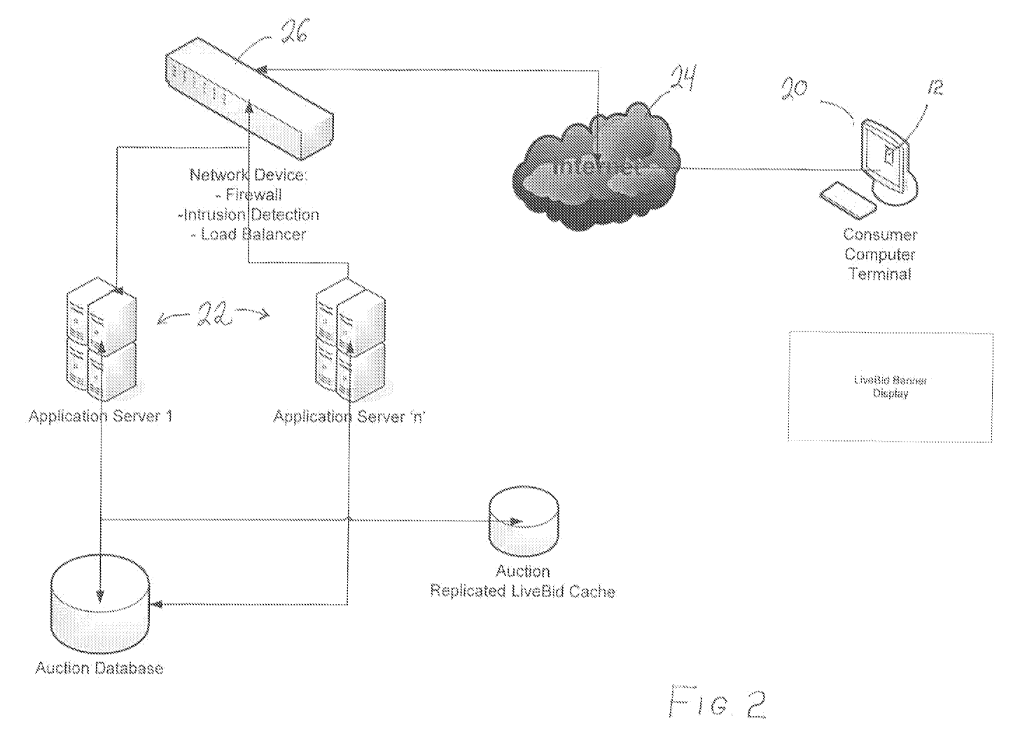

FIG. 2 is a schematic illustration of a system constructed and used in accordance with the invention. As illustrated in FIG. 2, a client server 20 communicates with an application server 22 via the Internet 24 via a network device 26. The application server 22 hosts the advertiser's application software and data, such as a central bidding database and relational database (e.g., Oracle, Microsoft SQL Server, IBM DB/2, Postgres, MySQL, Sybase, etc.). The banner is preferably, but not necessarily, designed with Flash® platform utilizing the http protocol, as this is currently the most portable way of imbedding complex communication and logic programming within a browser framework. Other specific client-side technologies are within the scope of the invention, and could achieve similar affects for a live banner ad. Examples are JAVA Applets, AJAX (Asynchronous JavaScript and XML) and Active X Plugin technologies.

The network device 26 is typically a Cisco® device that provides a firewall, an intrusion detection system, a load balancer and a switch. A typical network device comprises a Linux operating system, an Apache web server, a MySQL Database server and a PHP script, although those of ordinary skill in the art will recognize that other operating systems, web servers, database servers and scripts could be used without departing from the scope of the invention.

An initial http (or https) request is made by the client server to the network device via Flash®. The request is relayed to the application server, which responds back to the client server. The initial request can be sent in an html FORM POST format or other format; as described in detail below, however, the preferred system uses a non-standard response format to reduce the size of the transmitted code.

In accordance with the preferred system and methodology, there are 2 types of requests. The first is an initial request by the client for products that match search criteria selected by the publisher or the auction site pursuant to the agreement between them. In the following example, the search (Step 2 ) is for items in “category 237” that are the subject of auctions closing soon, wherein the category number has been assigned by the auction site to denote a particular category of items. The second type of request (Step 4) occurs in a loop, wherein data for requested auctions is periodically updated, as explained below.
Step 1: In order for the FLASH banner ad to communicate with the auction server, given the browser security restrictions currently implemented in all modern web browsers, the FLASH banner must first make a request to any server that it intends to communicate with. The request is for a file located in the root directory of the auction site's web server and named crossdomain.xml. By way of example, the file would be located in the bidz.com server as
   http://www.bidz.com/crossdomain.xml

The content of the foregoing file dictates which domains that host the FLASH banner can communicate with the auction server application host. By way of example, a crossdomain.xml file would have the following content to specify that banner ads hosted from llpromo.bidz.com and svimage.bidz.com have access rights to communicate with the application hosted at www.bidz.com:

<? xml version=“1.0”?>
- <!-- Access Policy for Bidz Live Banner -->
- <cross-domain-policy>
<allow-access-from domain=“llpromo.bidz.com” />
<allow-access-from domain=“svimage.bidz.com” />
</cross-domain-policy>

Step 2: Client sends the following XML over http (or https) request to the auction server via the banner ad:
Initialization
Request currently closing auctions XML
http://www.bidz.com/bzJApp/TopAuctions.action?tid=100&sid=100&query=categoryId:237
Step 3: The auction server sends a response back to the client in XML format identifying the appropriate number of on-going auctions (in this example, two auctions) that meet the criteria established by the publisher and/or auction site (with displayed blank spacing omitted herein for the sake of readability):

<auctions>
<auction id=“34874152”>
<brand></brand>
<thumburl>http://llthumb.bidz.com/80/95/01.jpg</thumburl>
<title>Elegant Ring With 0.90ctw Genuine Sapphires Made of 925
Sterling silver- Size 9 - Certificate Available.</title>
<productlink>http://www.bidz.com/bzJApp/ProductDisplay.action?sid=
100&tid=100&auctionId=34874152</productlink>
<pricetype>compare </pricetype>
<price>$89.00</price>
</auction>
<auction id=“34868656”>
<brand></brand>
<thumburl>http://llthumb.bidz.com/1/11/57/81.jpg</thumburl>
<title>Attractive Solitaire Ring With 14.85ctw Genuine Topaz Crafted in
Yellow Gold. Total item weight 7.7g - Size 7 - Certificate
Available.</title>
<productlink>http://www.bidz.com/bzJApp/ProductDisplay.action?sid=
100&tid=100&auctionId=34868656</productlink>
<pricetype> compare </pricetype>
<price>$979.00</price>
</auction>
</auctions>

The auction server has thus identified two auctions that meet the search criteria: auctions identified by the numbers 34874152 and 34868656, and has sent the response back in an abbreviated XML code that. The auction server accordingly sends a response back to the client in XML format.
Step 4:

The client sends a periodic request for updated data to the auction server; preferably, once per second. The client first extracts the auction number from the auction site's previous response; e.g., 34874152, and sends a request for live information for the extracted number in the following preferred format:
http://www.bidz.com/bzJApp/LiveProduct.action?sid=100&tid=100&auctionId=34874152

The auction server responds with updated data such as:
an=34874152
bc=17
wn=olguita2708
et=0,0,0,8
cb=45.0
nb=46.0
cl=N
ct=2009-05-07 11:56:00 AM PDT
at=E
rs=N
lb=mama4eva
bi=45.0
<br>

where:
an is the auction number
bc is the current bid count
wn is the identification of the winner
cb is the amount of the then-current bid
nb is the amount of the next bid
cl shows whether the auction is closed (Y/N)
ct is the time of the auction's close
at is the auction type (e.g., “E” means English)
rs tells whether there is a reserve (Y/N)
lb identifies the low bidder
bi is the bidding increment
<br> indicates that a new record is coming

On the next query to the auction server, the auction server responds to the next request; for example:
an=34874152
bc=17
wn=olguita2708
et=0,0,0,7
cb=45.0
cl=N
ct=2009-05-07 11:56:00 AM PDT
at=E
rs=N
lb=mama4eva
bi=45.0
<br>

In response to the next query, the auction server responds, for example, as follows:
an=34874152
bc=17
wn=olguita2708
et=0,0,0,6
cb=45.0
nb=46.0
cl=N
ct=2009-05-07 11:56:00 AM PDT
at=E
rs=N
lb=mama4eva
bi=45.0
<br>

The request and response cycle is repeated until the auction closes or the viewer switches to a different webpage, whichever occurs first.
Step 5:

The viewer wishing to join an auction displayed in the banner ad, and perhaps bid on the item, merely clicks on the banner ad or a button therein to be taken to the appropriate auction webpage. The viewer may first be transferred to a registration webpage where information pertaining to the viewer's identity can be obtained, or the registration procedure can be dealt with once the viewer decides to place a bid on the auction.

While the foregoing description includes detail that will enable those skilled in the art to practice the invention, it should be recognized that the description is illustrative in nature and that many modifications and variations will be apparent to those skilled in the art having the benefit of these teachings. It is accordingly intended that the invention herein be defined solely by the claims to be appended to the completed patent application, and that the claims be interpreted as broadly as permitted in light of the prior art.

I claim:

1. A system for diverting motivated bidders from a publisher's webpage to an on-line: auction site comprising:
an auction website server hosting an on-line auction and having an xml file with which a potential bidder's web browser can communicate via a banner ad displayed at a publisher's website to request a list of authorized domains having access rights to communicate with the on-line auction server;
means permitting the potential bidder's web browser to open a channel of communication to the auction website's webpage in http or https format to obtain a listing from the on-line auction website of at least one auction at the on-line auction website that is ending soon and meets search criteria specific to the publisher's webpage as previously selected by one or both of the on-line website and the publisher, said listing being in http or https format and being displayed as content within the banner ad;
means for establishing a request loop between the web browser and the on-line auction website that periodically updates the content in the banner ad to reflect, in essentially real time, updated data pertaining to the at least one listed auction listed within the banner ad, the updated data including the then-winning bid and the time remaining until auction close; and
means permitting the potential bidder to click through to the on-line auction website via the banner ad to participate in at least one of the at least one listed auction.

2. The system of claim 1 including:
an application server for communicating with a client server via the Internet, the application server hosting the on-line auction site's application software and data.

3. The system of claim 1 wherein the banner ad is designed with Flash® platform utilizing the http or https protocol.

4. The system of claim 1 wherein the banner ad data is updated approximately once per second to closely approximate real time updating.

5. The system of claim 1 wherein the banner ad is designed with a client-side technology selected from the group consisting of JAVA Applets, AJAX (Asynchronous JavaScript and XML) and Active X Plugin, and utilizes the http or https protocol.

6. A method for diverting motivated bidders from a publisher's webpage to an on-line auction site comprising the steps of:
providing an xml file on an on-line auction website server that hosts an on-line auction to enable a potential bidder's web browser to request, via a banner ad displayed at a publisher's website, a list of authorized domains having access rights to communicate with the on-line auction server;
permitting the potential bidder's web browser to open a channel of communication to the auction website's webpage in http or https format to obtain a listing from the on-line auction website of at least one auction at the on-line auction website that is ending soon and meets search criteria specific to the publisher's webpage as previously selected by one or both of the on-line website and the publisher, said listing being in http or https format and being displayed as content within the banner ad;
establishing a request loop between the web browser and the on-line auction website that periodically updates the content in the banner ad to reflect, in essentially real time, updated data pertaining to the at least one listed auction listed within the banner ad, the updated data including the then-winning bid and the time remaining until auction close; and
permitting the potential bidder to click through to the on-line auction website via the banner ad to participate in at least one of the at least one listed auction.

7. The method of claim 6 including:
communicating with a client server with an application server via the Internet, the application server hosting the on-line auction site's application software and data.

8. The method of claim 6 wherein the banner ad is designed with Flash® platform utilizing the http or https protocol.

9. The method of claim 6 wherein the updating step is performed approximately once per second to closely approximate real time updating.

10. The method of claim 6 wherein the banner ad is designed a client-side technology selected from the group consisting of JAVA Applets, AJAX (Asynchronous JavaScript and XML) and Active X Plugin, and utilizes Flash® platform.
